(19) United States
(12) Patent Application Publication
(10) Pub. No.: US 2026/0350383 A1
(43) Pub. Date: Nov. 5, 2026

(54) METHODS FOR LEARNING MULTI-TASK AI/ML-BASED FUNCTIONS

(71) Applicant: InterDigital Patent Holdings, Inc., Wilmington, DE (US)

(72) Inventors: Mohamed Amine Arfaoui, Montreal (CA); Philip Pietraski, Jericho, NY (US); Guodong Zhang, Woodbury, NY (US); Asil Koc, Verdun (CA); John Kaewell, Jamison, PA (US); Daniel Steinbach, Commack, NY (US)

(73) Assignee: InterDigital Patent Holdings, Inc., Wilmington, DE (US)

(21) Appl. No.: 19/197,430

(22) Filed: May 2, 2025

(51) Int. Cl. G06N 3/08; H04W 24/10

(52) U.S. Cl. CPC G06N 3/08; H04W 24/10

(57) ABSTRACT

A method may be implemented by a wireless transmit/receive unit (WTRU), and may include determining to train an artificial intelligence or machine learning (AI/ML)-based function, determining that the AI/ML-based function to be trained is a multi-task AI/ML-based function, and determining to perform curriculum learning for the multi-task AI/ML-based function to be trained. The determining to perform curriculum learning may be based on a command or message received from a network or a performance measurement. A configuration message associated with curriculum learning of a multi-task AI/ML-based function may be received from the network. The multi-task AI/ML-based function may be associated with a plurality of tasks. At least a subset of the plurality of tasks may be trained based on the configuration message. A report may be sent to the network. The report may indicate a status of the training of the plurality of tasks associated with the multi-task AI/ML-based function.

### BACKGROUND

Artificial intelligence (AI) may be broadly defined as behavior exhibited by machines that may mimic cognitive functions to sense, reason, adapt, and act. An AI component may refer to the realization of behaviors and/or conformance to requirements by learning based on data, without explicit configuration of a sequence of steps of actions. Such an AI component may enable learning of complex behaviors that may be difficult to specify and/or implement when using legacy methods.

### SUMMARY

A wireless transmit/receive unit (WTRU) may be described herein. The WTRU may include a processor. The processor may be configured to determine to train an artificial intelligence or machine learning (AI/ML)-based function, determine that the AI/ML-based function to be trained is a multi-task AI/ML-based function, and determine to perform curriculum learning for the determined multi-task AI/ML-based function to be trained. The determination to perform curriculum learning may be based on one or more of a command or message received from a network or a performance measurement. The processor may be configured to receive, from a network, a configuration message associated with curriculum learning of a multi-task AI/ML-based function. The multi-task AI/ML-based function may be associated with a plurality of tasks. The processor may be configured to train at least a subset of the plurality of tasks based on the configuration message, and to send a report to the network. The report may indicate a status of the training of the plurality of tasks associated with the multi-task AI/ML-based function.

Each task of the plurality of tasks may define a different learning objective of the multi-task AI/ML-based function. Each task of the plurality of tasks may define a different problem that is solved by the multi-task AI/ML-based function. Each task of the plurality of tasks may be defined by a different dataset or target label, or a different loss function. Each task of the plurality of tasks may be associated with a different skill or ability of the multi-task AI/ML-based function.

The processor may be configured to determine to transition from training a current task to a next task of the plurality of tasks associated with the multi-task AI/ML-based function based on one or more of an indication received from the network or a comparison of a performance metric associated with the current task to a configured threshold. The processor may be configured to determine an order of the subset of the plurality of tasks to be trained based on one or more of task complexity, training difficulty, dependency relationships among the tasks, performance measurements associated with the tasks, or recommendations received from the network.

The configuration message may include one or more of an indication of training data used to train the plurality of tasks associated with the multi-task AI/ML-based function, a list of tasks associated with the multi-task AI/ML-based function, a training approach to be used for training the plurality of tasks associated with the multi-task AI/ML-based function, or a training data used to train the plurality of tasks associated with the multi-task AI/ML-based function. The processor may be configured to determine the plurality of tasks to be trained based on one or more of a command triggering curriculum learning, the configuration message, or AI/ML-based function AI/ML model performance. The subset of the plurality of tasks may be based on received command/message triggering curriculum learning, received command/message triggering a start of training a set of tasks, curriculum learning configuration message, or AI/ML-based function AI/ML model performance.

The configuration message may include an indication of one or more of a training approach for the plurality of tasks, an allocation of training data, a mechanism to generate or reconstruct training data, or a mechanism to transfer training data to or from the WTRU and the network. The training approach may include one or more of parallel training, serial training, or cyclic training.

The processor may be configured to receive one or more AI/ML models for the AI/ML-based function, wherein the one or more AI/ML models comprise one or more of a single AI/ML model for the entire multi-task AI/ML-based function or a set of AI/ML models that are associated with the multi-task AI/ML-based function. Each AI/ML model of the set of AI/ML models may correspond to a specific task of the plurality of tasks.

The report may include training feedback associated with one or more of the plurality of tasks. The training feedback may include one or more of a gradient, a loss value, a derivative of a loss value, a reward signal, or state information.

The processor may be configured to receive an indication to stop training from the network.

The processor may be configured to determine to perform curriculum learning of the multi-task AI/ML-based function based on one or more of a command received from the network, detection of model drift of the multi-task AI/ML-based function, or based on a measurement associated with the multi-task AI/ML-based function falling below a threshold.

The processor may be configured to determine to transition from training a current task to a next task of the plurality of tasks based on a performance measurement threshold associated with the current task.

A method may be implemented by a wireless transmit/receive unit (WTRU), and may include determining to train an artificial intelligence or machine learning (AI/ML)-based function, determining that the AI/ML-based function to be trained is a multi-task AI/ML-based function, and determining to perform curriculum learning for the multi-task AI/ML-based function to be trained. The determining to perform curriculum learning may be based on a command or message received from a network or a performance measurement. A configuration message associated with curriculum learning of a multi-task AI/ML-based function may be received from the network. The multi-task AI/ML-based function may be associated with a plurality of tasks. At least a subset of the plurality of tasks may be trained based on the configuration message. A report may be sent to the network. The report may indicate a status of the training of the plurality of tasks associated with the multi-task AI/ML-based function.

Each task of the plurality of tasks may define a different learning objective of the multi-task AI/ML-based function. Each task of the plurality of tasks may define a different problem that is solved by the multi-task AI/ML-based function. Each task of the plurality of tasks may be defined by a different dataset or target label, or a different loss function. Each task of the plurality of tasks may be associated with a different skill or ability of the multi-task AI/ML-based function.

The method may include determining to transition from training a current task to a next task of the plurality of tasks associated with the multi-task AI/ML-based function based on one or more of an indication received from the network or a comparison of a performance metric associated with the current task to a configured threshold, and determining an order of the subset of the plurality of tasks to be trained based on one or more of task complexity, training difficulty, dependency relationships among the tasks, performance measurements associated with the tasks, or recommendations received from the network.

The configuration message may include one or more of an indication of training data used to train the plurality of tasks associated with the multi-task AI/ML-based function, a list of tasks associated with the multi-task AI/ML-based function, a training approach to be used for training the plurality of tasks associated with the multi-task AI/ML-based function, or a training data used to train the plurality of tasks associated with the multi-task AI/ML-based function. The method may include determining the plurality of tasks to be trained based on one or more of a command triggering curriculum learning, the configuration message, or AI/ML-based function AI/ML model performance. The subset of the plurality of tasks may be based on received command/message triggering curriculum learning, received command/message triggering a start of training a set of tasks, curriculum learning configuration message, or AI/ML-based function AI/ML model performance.

The configuration message may include an indication of one or more of a training approach for the plurality of tasks, an allocation of training data, a mechanism to generate or reconstruct training data, or a mechanism to transfer training data to or from the WTRU and the network. The training approach may include one or more of parallel training, serial training, or cyclic training.

The method may include receiving one or more AI/ML models for the AI/ML-based function, wherein the one or more AI/ML models comprise one or more of a single AI/ML model for the entire multi-task AI/ML-based function or a set of AI/ML models that are associated with the multi-task AI/ML-based function. Each AI/ML model of the set of AI/ML models may correspond to a specific task of the plurality of tasks.

The report may include training feedback associated with one or more of the plurality of tasks. The training feedback may include one or more of a gradient, a loss value, a derivative of a loss value, a reward signal, or state information.

The method may include receiving an indication to stop training from the network.

The method may include determining to perform curriculum learning of the multi-task AI/ML-based function based on one or more of a command received from the network, detection of model drift of the multi-task AI/ML-based function, or a measurement associated with the multi-task AI/ML-based function falling below a threshold.

The method may include determining to transition from training a current task to a next task of the plurality of tasks based on a performance measurement threshold associated with the current task.

A wireless transmit/receive unit (WTRU) may be described herein. The WTRU may include a processor. The processor may be configured to receive, from a network, a configuration message associated with curriculum learning of a multi-task artificial intelligence or machine learning (AI/ML)-based function. The multi-task AI/ML-based function may be associated with a plurality of tasks. The processor may be configured to train at least a subset of the plurality of tasks based on the configuration message, and to send a report to the network. The report may indicate a status of the training of the plurality of tasks associated with the multi-task AI/ML-based function.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 is a diagram illustrating an example method for curriculum learning according to an embodiment.

FIG. 3 is a diagram illustrating an example system architecture for an artificial intelligence or machine learning (AI/ML)-based hybrid automatic repeat request (HARQ) feedback mechanism according to an embodiment.

FIG. 4 is a diagram illustrating example wireless transmit/receive unit (WTRU) procedures to perform curriculum learning for a multi-task AI/ML-based function according to an embodiment.

FIG. 5 is a diagram illustrating an artificial intelligence or machine learning (AI/ML) model of the AI/ML-based hybrid automatic repeat request (HARQ) generation function at the WTRU.

FIG. 6 is a diagram illustrating an example artificial intelligence or machine learning (AI/ML) model of the hybrid automatic repeat request (HARQ) processing function at the network.

### DETAILED DESCRIPTION

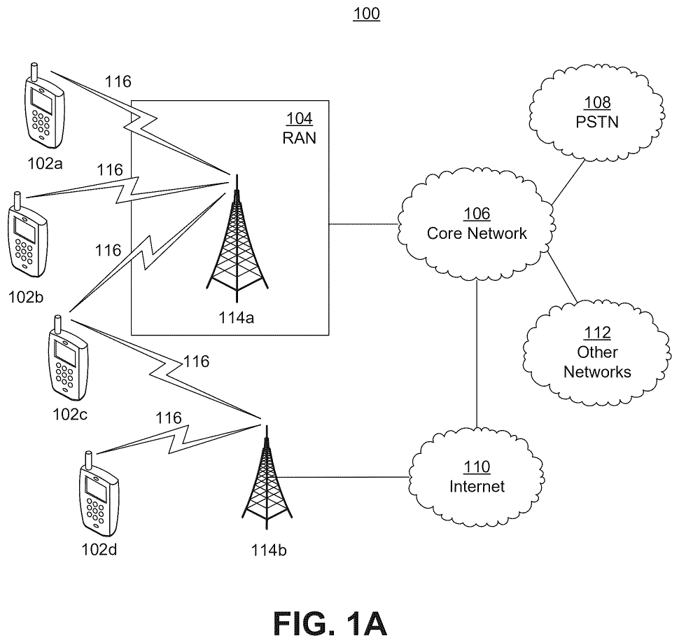

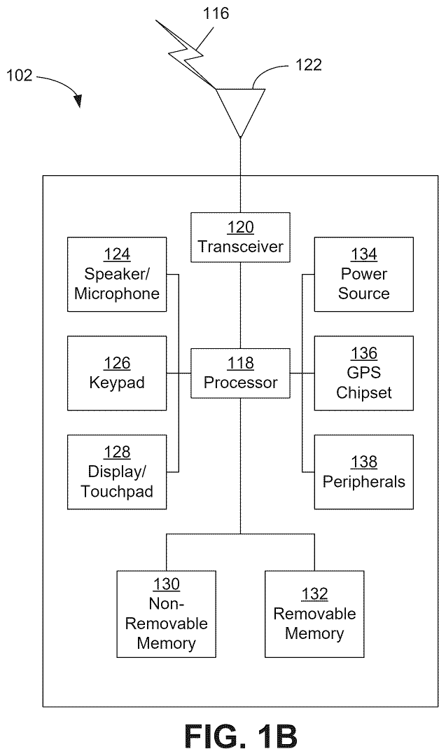

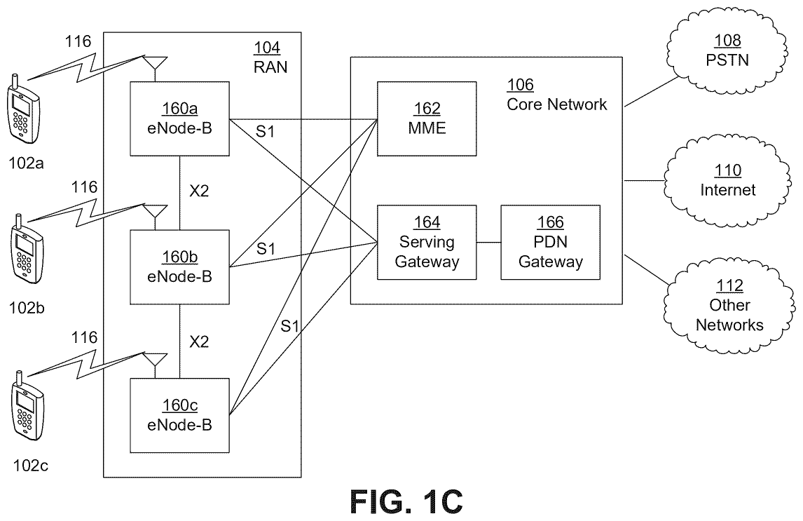

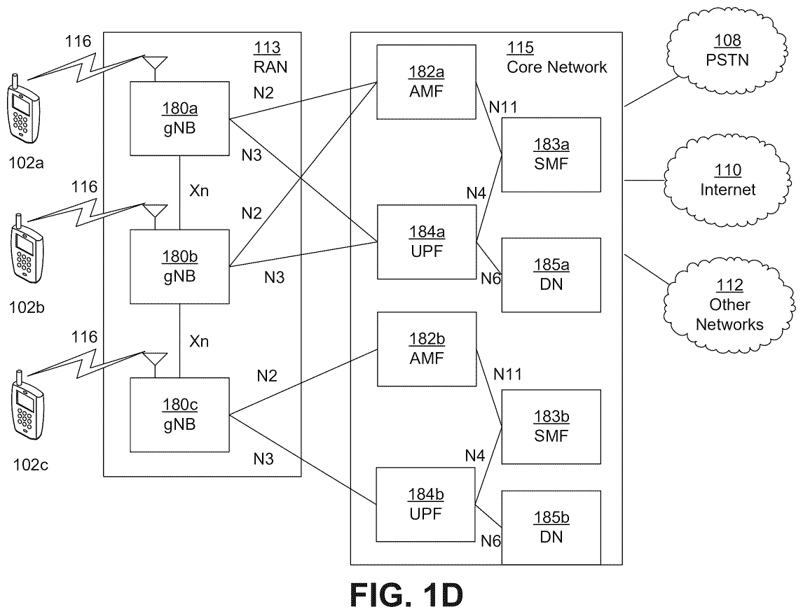

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a,184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Machine learning (ML) may refer to the type of algorithms that may solve a problem based on learning through experience (data), without being explicitly programmed (configuring a set of rules). ML may be considered as a subset of AI. Different ML paradigms may be envisioned based on the nature of data and/or feedback available to the learning algorithm. In a first example, a supervised learning approach may involve learning a function that maps input to an output based on labeled training examples, wherein each training example may be a pair consisting of an input and its corresponding output. In a second example, an unsupervised learning approach may involve detecting patterns in the data with no pre-existing labels. In a third example, a reinforcement learning approach may involve performing a sequence of actions in an environment to maximize cumulative reward. In some instances, it may be possible to apply ML algorithms using a combination and/or interpolation of the above-mentioned approaches. For example, a semi-supervised learning approach may use a combination of a small amount of labeled data with a large amount of unlabeled data during training. In this regard, semi-supervised learning may fall between unsupervised learning (with no labeled training data) and supervised learning (with only labeled training data).

Deep learning may refer to a class of ML algorithms that may employ artificial neural networks, specifically Deep Neural Networks (DNNs), which may be loosely inspired by biological systems. The DNNs may be a special class of ML models that may be inspired by the human brain, wherein the input may be linearly transformed and may pass through non-linear activation functions multiple times. The DNNs may consist of multiple layers, wherein each layer may include a linear transformation and a given non-linear activation function. The DNNs may be trained using the training data via a back-propagation algorithm. DNNs may provide state-of-the-art performance in a variety of domains (e.g., speech, vision, natural language, wireless communication, and/or other ML settings such as supervised, unsupervised, and/or semi-supervised learning).

The concept of curriculum learning in ML may involve ordering training data presented to the AI/ML model in a specific way, unlike a conventional approach in which training data may be randomly shuffled during training. This approach may be inspired by how humans may learn better when information is presented in a meaningful order. As such, ordering the training data before presenting the data to the AI/ML model from easy to hard may allow the AI/ML model to learn from the easier features before tackling the harder features.

Curriculum learning may be extended to a case in which the function to be learned by the AI/ML model may be segmented into multiple tasks. Specifically, curriculum learning for multiple tasks may be a training strategy in ML that may organize the learning process by structuring tasks in a meaningful sequence. Instead of learning all tasks jointly, this approach may introduce tasks progressively, starting with simpler and/or foundational tasks before moving to more complex and/or related tasks. This approach may also be inspired by how humans may learn by building upon basic knowledge before tackling advanced concepts. Accordingly, curriculum learning for multiple tasks may allow the AI/ML model to transfer knowledge from easier tasks, thereby improving learning efficiency, robustness, and overall performance on a collection of and/or all tasks. The order of tasks may significantly impact the overall effectiveness of curriculum learning by prioritizing tasks based on relevance and/or complexity.

As used herein, a ‘task’ may refer to any functional component, sub-function, sub-objective, learning objective, or problem definition associated with an artificial intelligence or machine learning (AI/ML)-based function. A task may be defined based on one or more characteristics, such as a particular learning goal, target output, dataset, label space, loss function, or skill to be acquired by the AI/ML-based function. Tasks may also differ based on processing requirements, training configurations, performance targets, input feature sets, or operational parameters. In some configurations, tasks may correspond to individual sub-functions within a multi-task AI/ML-based function, where each task is configured for separate training, monitoring, or performance evaluation. The determination of tasks may be provided explicitly (e.g., via signaling from a network node) or may be implicit based on configuration, received models, or operational objectives.

Examples provided herein may enable a WTRU and/or a NW to perform curriculum learning for multi-task AI/ML-based functions, and may include methods to train multi-task artificial intelligence or machine learning (AI/ML)-based functions for systems using AI/ML-based functions.

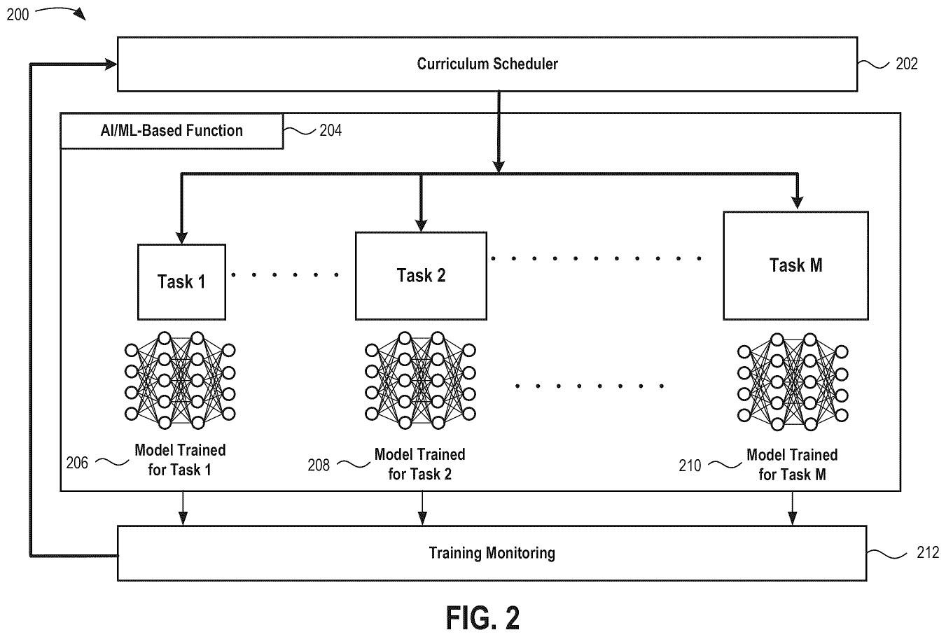

Referring now to FIG. 2, an example method 200 for curriculum learning is illustratively depicted. Considering that the function to be learned by the AI/ML model may be segmented into multiple tasks, a curriculum scheduler may organize the tasks to be learned by the AI/ML model in a specific way (e.g., increasing difficulty). The curriculum scheduler may arrange the training of the AI/ML model on the organized tasks. For each task, the training of the AI/ML model may be monitored. Once the training of the AI/ML model for a specific task may be complete, the curriculum scheduler may transfer the trained AI/ML model to the next arranged task and may use the trained AI/ML model as a pretrained AI/ML model for the next arranged task.

Curriculum learning may bring several benefits to machine learning (ML) and multi-task training. Curriculum learning may improve learning efficiency by enabling the model to build foundational knowledge before tackling harder problems, thereby improving learning speed and quality. Curriculum learning may enhance generalization, as curriculum learning may help models generalize better across different tasks and datasets by sharing information effectively between tasks. Curriculum learning may improve robustness, as gradual learning may reduce the risk of overfitting to complex tasks in training. Curriculum learning may provide a more stable and robust learning process, which may ensure consistent results. Curriculum learning may mimic the way humans learn by starting with easier tasks and progressing to harder ones, thereby making the training process more intuitive and interpretable.

In a communication system (e.g., fifth generation new radio (5G NR) systems and beyond), some functions and/or mechanisms (e.g., channel state information (CSI) feedback reporting, scheduling, forward error correction (FEC) coding, modulation, receiver functions, and/or hybrid automatic repeat request (HARQ)) may be artificial intelligence or machine learning (AI/ML)-based functions. Some of these functions may be modeled as a set of tasks arranged in a specific way to fulfill their end goals, wherein the functions may be multi-task AI/ML-based functions and/or mechanisms. Conventional approaches for training multi-task AI/ML-based functions and/or mechanisms may rely on training the entire multi-task AI/ML-based function and/or mechanism for all tasks simultaneously and/or using all available data jointly. Such approaches may increase training complexity and/or may increase susceptibility to underfitting and/or overfitting. Motivated by this, a more efficient approach for training multi-task AI/ML-based functions and/or mechanisms may be highly desirable.

Examples described herein may include a training approach for multi-task AI/ML-based functions of communication systems (e.g., 5G NR systems and beyond). The proposed training approach may be based on curriculum learning, wherein the tasks of the AI/ML-based function may be organized in a specific way (e.g., based on task complexity and/or training complexity). Specifically, considering an AI/ML-based function of the communication system (e.g., CSI feedback reporting, scheduling, FEC coding, modulation, receiver functions, and/or HARQ) that may be segmented into a set of M tasks, a network (NW) may schedule a combination of N tasks, from the M tasks, to be trained based on measurements performed by the NW and/or a wireless transmit/receive unit (WTRU), and/or based on recommendations from the WTRU. The NW may decide on a training strategy for the N tasks to be operated, wherein the training strategy may include parallel training, serial training, and/or cyclic training.

The training approach may refer to the mode or schedule by which the plurality of tasks of the multi-task AI/ML-based function are trained, including, for example, parallel training (training multiple tasks concurrently), serial training (task-by-task sequencing), and/or cyclic training (rotating among tasks periodically).

In examples, one or more of the operations, procedures, and/or functionalities described herein may be segmented into independently trainable components, subtasks, and/or modular functional blocks. Such segmentation may enable alternative learning arrangements, partial training of specific subtasks, or selective re-training of individual tasks within an AI/ML-based function. The subtasks and modular functional blocks may be defined based on functionality, performance objectives, data characteristics, training complexity, or network-directed configuration. Training may be performed jointly or separately for different components, allowing adaptive reconfiguration of the AI/ML-based function.

In addition to, for example, task complexity and/or training complexity, the ordering and selection of tasks for training may be determined based on a variety of factors, such as historical performance of tasks, estimated task interdependencies, latency targets, error rates, resource availability at the WTRU and/or the NW, energy efficiency considerations, mobility state of the WTRU, or task priority levels as configured by the NW and/or determined by the WTRU.

Referring to FIG. 2,the curriculum scheduler 202 may organize and coordinate the training of an AI/ML-based function 204, which may comprise a plurality of tasks (e.g., Task 1, Task 2, and/or Task M). It is to be appreciated that references to tasks herein may use either numerical identifiers (e.g., Task 1, Task 2) or descriptive terms such as “initial task”, “current task”, “subsequent task,” “additional task,” or similar, and such terminology may be used interchangeably throughout this disclosure. A model trained for Task 1 (e.g., initial task) is depicted at 206, a model trained for Task 2 (e.g., subsequent task) is depicted at 208, and a model trained for Task M is depicted at 210. The curriculum scheduler 202 may arrange the sequence in which the AI/ML-based function 204 may be trained on the tasks (e.g., from Task 1 to Task 2 to Task M, based on an ordering such as increasing difficulty and/or complexity). Training monitoring 212 may observe and/or track the progress of training for each of the tasks, and the curriculum scheduler 202 may manage the transfer of pretrained models from one task to the next task in the sequence, such that the pretrained AI/ML model trained for a given task may be used as the starting point for training the next arranged task.

The WTRU procedures to perform curriculum learning for multi-task AI/ML-based functions may be described as follows. The NW may refer to any node in the network (e.g., a next-generation Node B (gNB), another WTRU such as in sidelink or WTRU-to-WTRU direct communication, and/or other nodes).

The WTRU may be triggered to start training for a specific AI/ML-based function. Triggers to initiate training may include the WTRU receiving a command and/or message that may trigger training (e.g., a command triggering start), the WTRU being configured to use AI/ML for the function (e.g., for a first time), and/or the WTRU and/or the NW detecting a need to initiate training. For example, AI/ML model drift detection mechanisms at the WTRU and/or the NW may indicate that the AI/ML models may have drifted and/or may be drifting. Additionally, and/or alternatively, the WTRU may enter a geographic region and/or a cell (e.g., a new cell identifier or a new registration area) for which the function may not have been previously trained.

The WTRU may determine whether the AI/ML-based function to be trained is a multi-task AI/ML-based function. The WTRU may receive a message (e.g., from the NW) that may comprise an indication that the AI/ML-based function is a multi-task AI/ML-based function, wherein the indication may include a list of tasks embedded in the AI/ML-based function. Additionally and/or alternatively, the WTRU may determine that the AI/ML-based function is a multi-task AI/ML-based function based on a configuration associated with the AI/ML-based function, wherein the configuration may be received when the WTRU may be configured with the AI/ML-based function and/or when a model applicable to the AI/ML-based function may be received. The WTRU may transmit a message to the NW that may comprise an indication that the AI/ML-based function is a multi-task AI/ML-based function, wherein the indication may include the list of tasks embedded in the AI/ML-based function.

The WTRU may receive one or more AI/ML models for the AI/ML-based function from the NW. The WTRU may receive a single AI/ML model for the entire AI/ML-based function and/or a set of AI/ML models, wherein each AI/ML model may correspond to a specific task within the AI/ML-based function.

The WTRU may determine to perform curriculum learning for the determined AI/ML-based function. For example, the WTRU may determine to perform curriculum learning based on receiving a command and/or message (e.g., a command triggering curriculum learning) from the NW and/or based on measurements (e.g., performance measurements) performed at the WTRU. The WTRU may determine to start training a set of tasks within the AI/ML-based function, for example based on receiving a command and/or message from the NW. The command and/or message may include the set of tasks to be trained within the AI/ML-based function and may include the training strategy for the set of tasks to be trained. The list of training strategies may include parallel training, serial training, and/or cyclic training. The training may be periodic, aperiodic, and/or semi-persistent.

The WTRU may receive, from the NW, a configuration message for curriculum learning. The configuration message may include at least one of a training data configuration for one or more tasks, which may include training data allocations, mechanisms to generate and/or reconstruct training data (e.g., random seeds, modulation and coding scheme (MCS) values, and/or other parameters), and mechanisms to transfer training data to and/or from the WTRU and/or the NW. The configuration message may additionally and/or alternatively include signals and/or uplink resource configurations and/or allocations that may carry training feedback to and/or from the WTRU and/or the NW. For example, the signals and/or uplink resource configurations and/or allocations may include physical downlink shared channel (PDSCH), physical downlink control channel (PDCCH), radio resource control (RRC), downlink control information (DCI), and/or medium access control control element (MAC-CE) for training feedback transmitted from the NW to the WTRU. Similarly, physical uplink shared channel (PUSCH), physical uplink control channel (PUCCH), RRC, uplink control information (UCI), and/or MAC-CE may be used for training feedback transmitted from the WTRU to the NW. The training feedback may include gradients, loss values, derivatives of loss values, and/or other data (e.g., in the case of supervised learning), and/or reward, state, and/or other data (e.g., in the case of reinforcement learning). The configuration message may further include thresholds and/or mechanisms to monitor the training of one or more tasks. The WTRU may receive the configuration message through one or more of DCI, MAC-CE, and/or RRC signaling.

The WTRU may determine the set of tasks to be trained based on one or more of a received command and/or message triggering curriculum learning, a received command and/or message triggering the start of training for a set of tasks, the configuration message for curriculum learning, and/or the AI/ML-based function AI/ML model performance. The WTRU may train the set of tasks based on the received configuration message. The WTRU may determine to transition from training a given task (or a group of tasks out of the list of multiple tasks) to the next configured task (or the next group of tasks out of the list of configured multiple tasks). Triggers for transitioning from training a certain subtask to the next subtask (or transitioning from training a group of subtasks to the next group of subtasks) may include WTRU selection, NW indication, and/or measurements (e.g., performance measurements).

It is to be appreciated that any of the triggering mechanisms, task determination operations, training configuration elements, sequencing strategies, feedback monitoring procedures, and/or transitioning criteria described herein may be claimed individually or in any combination. For example, the determination to initiate training, the task selection process, and/or the transitioning decisions may each be performed independently or jointly with other operations as described, or may be coordinated across WTRU-side and NW-side functions.

Alternative triggering mechanisms may be provided. For example, triggers for initiating training may be based on any number of internal WTRU conditions, network-side evaluations, and/or predictive analytics-based determinations. Triggers may be configured dynamically or semi-persistently via signaling, configuration messaging, and/or autonomously by the WTRU based on learned operational parameters. Trigger conditions may comprise, for example, system performance thresholds (e.g., performance measurement thresholds), environmental context, model drift detection, data quality metrics, and/or predefined time intervals.

The WTRU may report training status to the NW and/or may receive training status from the NW. The WTRU may report training feedback to the NW for each configured task (or a group of tasks) and/or may receive training feedback from the NW for each configured task (or a group of tasks). The WTRU and/or the NW may monitor the training progress of each task. The WTRU may receive, from the NW, an indication to stop training, for example, based on completion of training.

The NW may transmit an AI/ML capabilities request to the WTRU and/or may receive AI/ML capabilities from the WTRU. The NW may determine and may transmit one or more appropriate AI/ML models for the AI/ML-based function, wherein the NW may transmit a single AI/ML model for the entire AI/ML-based function and/or a set of AI/ML models, each corresponding to a specific task (or a group of tasks) within the AI/ML-based function. The NW may transmit a command and/or message to the WTRU to perform curriculum learning for the determined AI/ML-based function. The NW may transmit a command and/or message to the WTRU to start training a set of tasks within the AI/ML-based function. The NW may transmit a configuration message to the WTRU. The NW may monitor the training progress based on the received training status from the WTRU. The NW may transmit an indication to the WTRU to stop training.

Network-side configuration strategies may be adaptable to allow partitioning of models across network nodes, dynamic reallocation of tasks among WTRUs, and/or assignment of different subtasks to different WTRUs. Such partitioning may support distributed training scenarios or resource-optimized curriculum learning architectures. Partitioning strategies may be determined based on processing capabilities, network topology, latency requirements, energy efficiency considerations, and/or performance optimization objectives.

Systems and methods described herein may include, for example, a training approach for multi-task artificial intelligence or machine learning (AI/ML)-based functions of communication systems (e.g., fifth generation new radio (5G NR) systems and beyond). Training approaches may be based on curriculum learning, wherein the tasks of the AI/ML-based function may be organized in a specific way (e.g., based on task complexity and/or training complexity). In some examples, by considering an AI/ML-based function of the communication system (e.g., channel state information (CSI) feedback reporting, scheduling, forward error correction (FEC) coding, modulation, receiver functions, and/or hybrid automatic repeat request (HARQ)) that may be segmented into a set of M tasks, the network (NW) may schedule a combination of N tasks, out of the M tasks, to be trained based on some measurements performed by the NW and/or a wireless transmit/receive unit (WTRU) and/or based on recommendations from the WTRU. The NW may decide on a training strategy for the N tasks to be operated, wherein the training strategy may include parallel training, serial training, and/or cyclic training.

AI/ML-based HARQ feedback mechanism is an example of multi-task AI/ML-based function that consists of two tasks. The first task (or a group of tasks) may be ACK/NACK feedback reconstruction, and the second task (or a group of tasks) may be designing Tx/Re Tx recommendation. As such, AI/ML-based HARQ feedback may be one exemplary use case where the curriculum learning approach may be applied. Details on how curriculum learning can be applied to AI/ML-based HARQ feedback are given in the following.

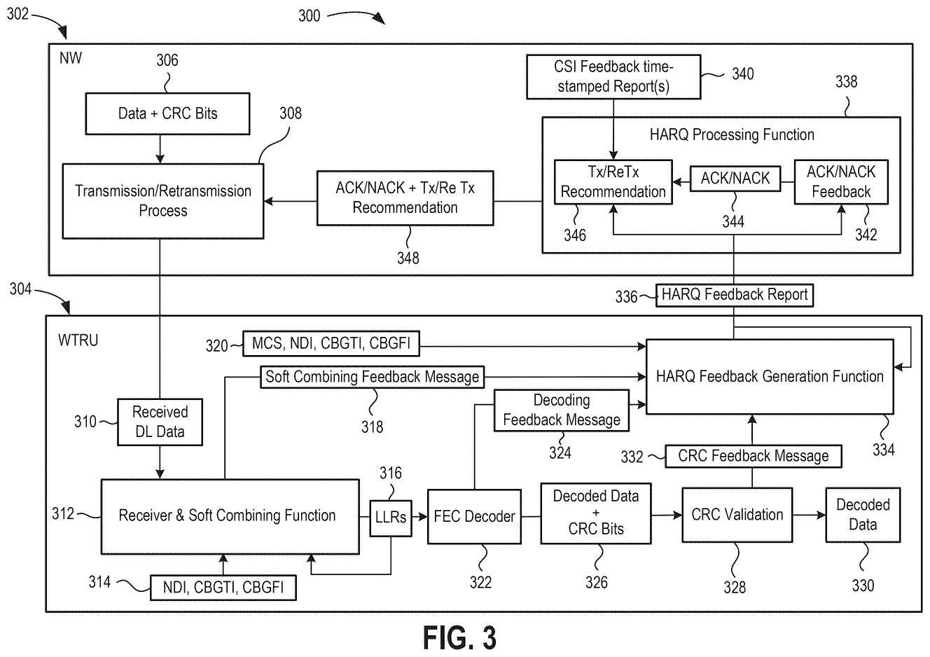

Referring now to FIG. 3, an example system 300 for an AI/ML-based HARQ feedback mechanism is illustratively depicted. The NW 302 may input data and cyclic redundancy check (CRC) bits at 306 to a transmission and/or retransmission process 308 and then may transmit the resulting data and CRC bits to the WTRU 304. The WTRU 304 may receive downlink (DL) data at 310 and may process the received DL data through a receiver and soft combining function 312. The receiver and soft combining function 312 may perform operations including channel estimation, equalization, demodulation, and/or soft combining. The receiver and soft combining function 312 may generate log-likelihood ratios (LLRs) at 316 and may also output a soft combining feedback message at 318. The soft combining feedback message at 318 may provide information about the operation and/or the output of soft combining (e.g., statistics of LLRs and/or resulting SINR), including one or more decoding parameters (e.g., modulation and coding scheme (MCS), new data indicator (NDI), code block group transmission indicator (CBGTI), and/or code block group feedback indicator (CBGFI).

The WTRU 304 may then apply forward error correction (FEC) decoding to the LLRs at an FEC decoder 322, which may output decoded data and CRC bits at 326 along with a decoding feedback message that includes statistics about the FEC decoding process (e.g., the number of iterations that the FEC decoder used to decode the resulting LLRs). This information reveals the complexity of data decoding (e.g., the comparative easiness or the hardness of decoding the resulting soft bits). The WTRU 304 may apply CRC validation at 328 to the decoded data and CRC bits 326. The CRC validation at 328 may check whether the hard bits of the transport blocks (TBs) and/or code block groups (CBGs), output from the FEC decoder 322, may be correctly decoded. The CRC validation 328 may generate a CRC feedback message that may include the total set of CRC bits. This information may help predict the number of retransmissions required based on the CRC error history from earlier iterations, including an indication of how close the WTRU 304 may have been to successfully decoding the TBs and/or CBGs.

The WTRU 304 may input one or more decoding parameters (e.g., the soft combining feedback message at 318, decoding feedback message at 324, CRC feedback message at 328, requested DL MCS, NDI, CBGTI, CBGFI, and/or other parameters at 320) to an AI/ML-based HARQ feedback generation function 334 and generates a HARQ feedback report 336. The WTRU 304 may also input previously generated HARQ feedback reports to the HARQ feedback generation function 334. The HARQ feedback generation function 334 may generate a HARQ feedback report at 336 in the form of a latent representation. The WTRU 304 may receive a configuration message from the NW 302, wherein the configuration message may include the size of the latent representation (e.g., number of latent variables), a specific quantization operation to be applied to the latent representation (e.g., number of bits per latent variable, uniform and/or non-uniform quantization, scalar and/or vector quantization), and/or other configuration parameters. The WTRU 304 may map the generated HARQ feedback report at 336 to configured uplink resources and may transmit the HARQ feedback report at 336 to the NW 302.

In some examples, configuration parameters (e.g., for curriculum learning-based training) may include, for example, one or more operational policies or criteria for adapting the training process in response to system-level events. Such configuration parameters may specify, for example, performance thresholds that may trigger task resequencing, the use of weighted training priorities between tasks, and/or the introduction of new tasks during an ongoing training session.

The NW 302 may receive the HARQ feedback report at 336. The NW 302 may input the received HARQ feedback report along with available CSI feedback time-stamped reports at 340 (associated with prior DL channel sounding operations) to an AI/ML-based HARQ processing function 338. The HARQ processing function 338 may reconstruct acknowledgment (ACK) and/or negative acknowledgment (NACK) feedback at 342, associated with the DL transmitted TBs and/or CBGs if the data transmission may be based on CBGs. The HARQ processing function 338 may also generate a transmission or retransmission (Tx/ReTx) recommendation at 346. The Tx/ReTx recommendation at 346 may include, but may not be limited to, an MCS, a predicted number of retransmissions for the generated MCS, a redundancy version buffer offset, a predicted number of retransmissions, and/or other parameters. The HARQ processing function 338 may provide ACK/NACK feedback at 344 to the Tx/ReTx recommendation process at 346, and ACK/NACK and Tx/ReTx recommendation outputs may be provided at 348 to the transmission and/or retransmission process 308.

Is it to be appreciated that while HARQ feedback generation and processing are described as an example multi-task AI/ML-based function, similar curriculum learning-based training approaches may be applied to other multi-task AI/ML-based functions (e.g., beam management, power control, interference mitigation, link adaptation, channel estimation, resource allocation, modulation and coding selection, and/or network slicing control) in some examples. The sequencing, feedback mechanisms, and/or training configurations disclosed herein may likewise be applied across these additional AI/ML-based functions, whether implemented at the WTRU, the NW, or in a distributed manner between them.

When a WTRU may be configured to perform curriculum learning, key parameters may be configured by the NW, which may include training data configuration for one or more tasks. The training data configuration may include training data allocations, mechanisms to generate and/or reconstruct training data (e.g., random seeds, MCS values, and/or other parameters), and mechanisms to transfer training data to and/or from the WTRU and/or the NW. The configuration may include signals and/or uplink resource configurations and/or allocations that may carry training feedback to and/or from the WTRU and/or the NW. For example, signals and/or uplink resource configurations and/or allocations may include physical downlink shared channel (PDSCH), physical downlink control channel (PDCCH), radio resource control (RRC), downlink control information (DCI), and/or medium access control control element (MAC-CE) for training feedback transmitted from the NW to the WTRU. Similarly, physical uplink shared channel (PUSCH), physical uplink control channel (PUCCH), RRC, uplink control information (UCI), and/or MAC-CE may be used for training feedback transmitted from the WTRU to the NW. The training feedback may include gradients, loss values, derivatives of loss values, and/or other data (e.g., in the case of supervised learning), and/or reward (e.g., reward signal), state, and/or other data (e.g., in the case of reinforcement learning). Feedback may further include, for example, learning rate adjustments, error prediction confidence levels, drift detection signals, variance of model outputs across iterations, convergence time indicators, and/or task-specific completion metrics. Such feedback may be used individually or in combination to guide task selection, training progression, and/or training termination decisions.

The configuration may further include thresholds and/or mechanisms to monitor the training of one or more tasks.

For a WTRU to perform curriculum learning, signaling may be defined as follows. A command and/or message triggering training of a specific AI/ML-based function may be transmitted from the NW to the WTRU. A message comprising an indication that the AI/ML-based function may be a multi-task AI/ML-based function may be transmitted from the NW to the WTRU and/or from the WTRU to the NW, wherein the indication may include the list of tasks embedded in the AI/ML-based function. A command and/or message triggering curriculum learning for the determined AI/ML-based function may be transmitted from the NW to the WTRU. A command and/or message triggering training of a set of tasks in the AI/ML-based function may be transmitted from the NW to the WTRU, wherein the command and/or message may include the set of tasks to be trained and may include the training strategy for the set of tasks to be trained. The training strategy may include parallel training, serial training, and/or cyclic training. A signal indicating a transition from training a certain subtask (or a group of subtasks) to the next subtask (or a group of subtasks) may be transmitted from the NW to the WTRU and/or from the WTRU to the NW. Training feedback reports may be transmitted from the WTRU to the NW and/or from the NW to the WTRU. An indication to stop training may be transmitted from the NW to the WTRU.

In some configurations, transfer learning, model migration, or reuse of pretrained models across tasks may be applied, wherein knowledge or weights from a previously trained task (or a group of tasks) may serve as an initialization or augmentation for subsequent tasks. Selective reuse of model parameters may be based on task (or a group of tasks) similarity, complexity ranking, or network-supplied recommendations. Model transfer may involve full model weights, selected layers, or extracted features, and may be configured per task and/or across groups of tasks depending on learning objectives.

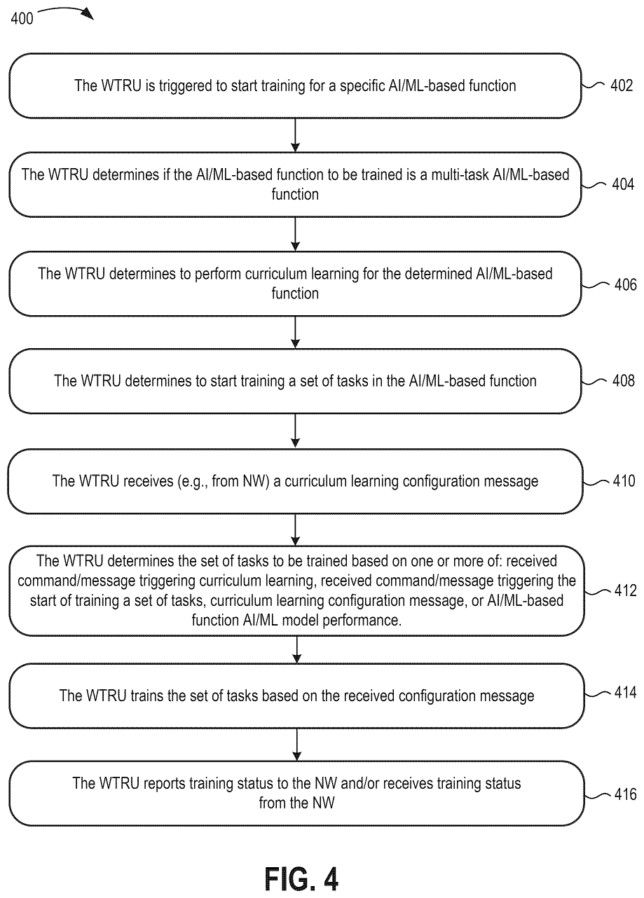

The wireless transmit/receive unit (WTRU) procedures to perform curriculum learning for multi-task artificial intelligence or machine learning (AI/ML)-based functions are detailed below and summarized in FIG. 4. The network (NW) may refer to any node in the network, such as a next-generation Node B (gNB), another WTRU (e.g., sidelink, WTRU-to-WTRU direct communication), and/or other network entities.

The scheduling of tasks for training and/or the determination of task sequences may additionally and/or alternatively be based on one or more of complexity metrics, resource constraints, dependency relationships among tasks, data availability, and/or historical task (or a group of tasks) performance outcomes. Task (or a group of tasks) prioritization may be performed according to policy-based rules, AI/ML-based selection logic, network optimization strategies, or combinations thereof. Such task (or a group of tasks) selection and scheduling may be static, dynamically adjustable, or responsive to real-time operational conditions.

Referring now to FIG. 4, an example method 400 for performing curriculum learning of a multi-task AI/ML-based function is illustratively depicted. At 402, the WTRU may be triggered to start training for a specific AI/ML-based function. Triggers to initiate training may include the WTRU receiving a command and/or message that may trigger training, the WTRU being configured to use AI/ML for the function (e.g., for a first time), and/or the WTRU and/or the NW detecting a need to initiate training. For example, AI/ML model drift detection mechanisms at the WTRU and/or the NW may indicate that the AI/ML models may have drifted and/or may be drifting. Additionally, and/or alternatively, the WTRU may enter a geographic region and/or a cell (e.g., a new cell identifier or a new registration area) for which the function may not have been previously trained.

At 404, the WTRU may determine whether the AI/ML-based function to be trained is a multi-task AI/ML-based function. The WTRU may receive a message (e.g., from the NW) that may comprise an indication that the AI/ML-based function is a multi-task AI/ML-based function, wherein the indication may include a list of tasks embedded in the AI/ML-based function. Additionally, and/or alternatively, the WTRU may determine that the AI/ML-based function is a multi-task AI/ML-based function based on a configuration associated with the AI/ML-based function. The configuration may be received when the WTRU may be configured with the AI/ML-based function and/or when a model applicable to the AI/ML-based function may be received. The WTRU may transmit a message to the NW that may comprise an indication that the AI/ML-based function is a multi-task AI/ML-based function, wherein the indication may include the list of tasks embedded in the AI/ML-based function.

The WTRU may receive one or more AI/ML models for the AI/ML-based function from the NW, wherein the WTRU may receive a single AI/ML model for the entire AI/ML-based function and/or a set of AI/ML models, each corresponding to a specific task (or a group of tasks) within the AI/ML-based function.

At 406, the WTRU may determine to perform curriculum learning for the determined AI/ML-based function. For example, the WTRU may determine to perform curriculum learning based on receiving a command and/or message from the NW and/or based on measurements (e.g., performance measurements) performed at the WTRU.

At 408, the WTRU may determine to start training a set of tasks in the AI/ML-based function. For example, the WTRU may determine to start training based on receiving a command and/or message from the NW, wherein the command and/or message may include the set of tasks to be trained within the AI/ML-based function. The command and/or message may also include the training strategy for the set of tasks to be trained, wherein the training strategy may include parallel training, serial training, and/or cyclic training. The training may be periodic, aperiodic, and/or semi-persistent.

At 410, the WTRU may receive, from the NW, a curriculum learning configuration message. The configuration message may include at least one of a training data configuration for one or more tasks, which may include training data allocations, mechanisms to generate and/or reconstruct training data (e.g., random seeds, modulation and coding scheme (MCS) values, and/or other parameters), and mechanisms to transfer training data to and/or from the WTRU and/or the NW. The configuration message may additionally and/or alternatively include signals and/or uplink resource configurations and/or allocations that may carry training feedback to and/or from the WTRU and/or the NW. For example, signals and/or uplink resource configurations and/or allocations may include physical downlink shared channel (PDSCH), physical downlink control channel (PDCCH), radio resource control (RRC), downlink control information (DCI), and/or medium access control control element (MAC-CE) for training feedback transmitted from the NW to the WTRU. Similarly, physical uplink shared channel (PUSCH), physical uplink control channel (PUCCH), RRC, uplink control information (UCI), and/or MAC-CE may be used for training feedback transmitted from the WTRU to the NW. The training feedback may include gradients, loss values, derivatives of loss values, and/or other data (e.g., in the case of supervised learning), and/or reward, state, and/or other data (e.g., in the case of reinforcement learning). The configuration message may further include thresholds and/or mechanisms to monitor the training of one or more tasks. The WTRU may receive the configuration message through one or more of DCI, MAC-CE, and/or RRC signaling.

At 412, the WTRU may determine the set of tasks to be trained based on one or more of a received command and/or message triggering curriculum learning, a received command and/or message triggering the start of training for a set of tasks, the configuration message for curriculum learning, and/or the AI/ML-based function AI/ML model performance.

At 414, the WTRU may train the set of tasks based on the received configuration message. The WTRU may also determine transitioning from training a given task (or a group of tasks) to the next configured task, wherein triggers for transitioning from training a certain subtask (or a group of subtasks) to the next subtask (or a group of subtasks) may include WTRU selection, NW indication, and/or measurements (e.g., performance measurements).

At 416, the WTRU may report training status to the NW and/or may receive training status from the NW. The WTRU may report training feedback to the NW for each configured task (or a group of tasks) and/or may receive training feedback from the NW for each configured task. The WTRU and/or the NW may monitor the training progress of each task. The WTRU may receive, from the NW, an indication to stop training, for example, based on completion of training.

The training feedback and/or monitoring mechanisms described herein may be further parameterized to allow variability in feedback content, periodicity, and reporting granularity. Feedback elements may be selected adaptively based on training state, task (or a group of tasks) priority, and/or network configuration. The feedback content may include different combinations of performance indicators, statistical summaries, raw metrics, and/or compressed representations of training status, wherein the selection of such feedback elements may be configured via signaling or autonomously by the WTRU.

The NW may transmit an AI/ML capabilities request to the WTRU and/or may receive AI/ML capabilities from the WTRU. The NW may determine and may transmit one or more appropriate AI/ML models for the AI/ML-based function, wherein the NW may transmit a single AI/ML model for the entire AI/ML-based function and/or a set of AI/ML models, each corresponding to a specific task (or a group of tasks) within the AI/ML-based function. The NW may transmit a command and/or message to the WTRU to perform curriculum learning for the determined AI/ML-based function. The NW may transmit a command and/or message to the WTRU to start training a set of tasks in the AI/ML-based function. The NW may transmit a configuration message to the WTRU. The NW may monitor the training progress based on the received training status. The NW may transmit an indication to the WTRU to stop training.

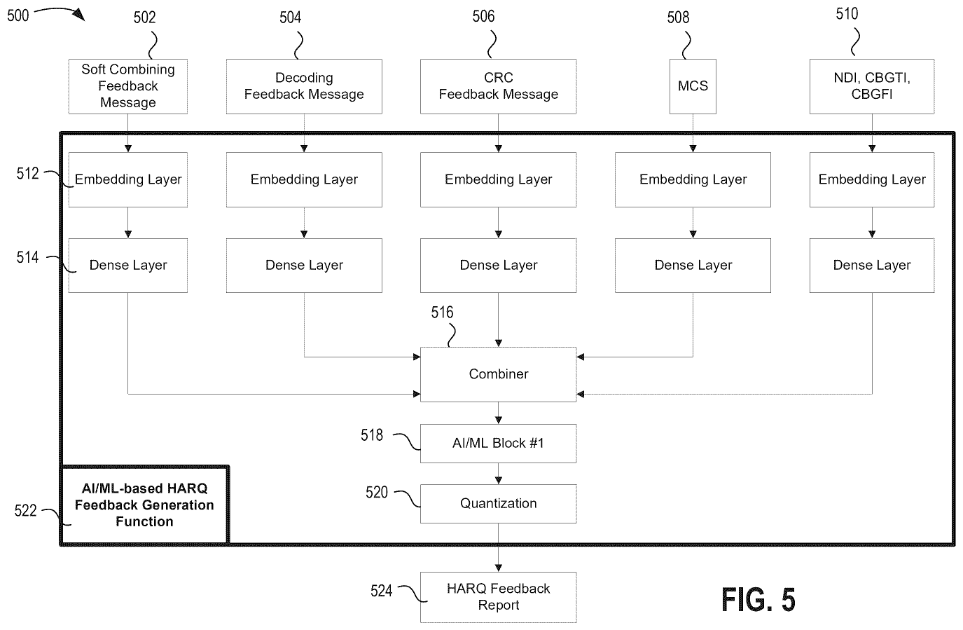

Referring now to FIG. 5, an example method 500 including an AI/ML-based HARQ feedback generation function 522 is illustratively depicted. Input data to the AI/ML-based HARQ feedback generation function 522 may include a soft combining feedback message 502, a decoding feedback message 504, a CRC feedback message 506, a modulation and coding scheme (MCS) value 508, and one or more indicators such as a new data indicator (NDI), a code block group transmission indicator (CBGTI), and/or a code block group feedback indicator (CBGFI) 510. The soft combining feedback message 502 may be explicit, such as statistics of the output LLRs and/or resulting SINR after soft combining, and/or a latent representation, such as a vector and/or tensor of real and/or binary values, for example if a neural receiver and/or the soft combining function is an AI/ML-based function.

Each input data 502, 504, 506, 508, and 510 may be provided to a corresponding embedding layer 512, which may generate a representation such as a numerical representation or a real-valued representation of that input data. Each generated representation from the embedding layer 512 may be provided to a corresponding dense layer 514. The generated representations may thereby be mapped into a shared space via learned transformations, such as mapping the generated representations to a common dimension. The outputs of the dense layers 514 may be combined by a combiner 516, such as via concatenation, addition, and/or another combination technique, to generate a single representation, such as a numerical representation or a real-valued representation.

The output of the combiner 516 may be provided to an AI/ML block 518. The AI/ML block 518 may include one or more hidden layers, such as one or more dense layers and/or one or more convolutional layers, to generate a latent representation. A quantization operation 520 may be applied to the latent representation generated by the AI/ML block 518 to generate a HARQ feedback report 524. The HARQ feedback report 524 may be output from the AI/ML-based HARQ feedback generation function 522.

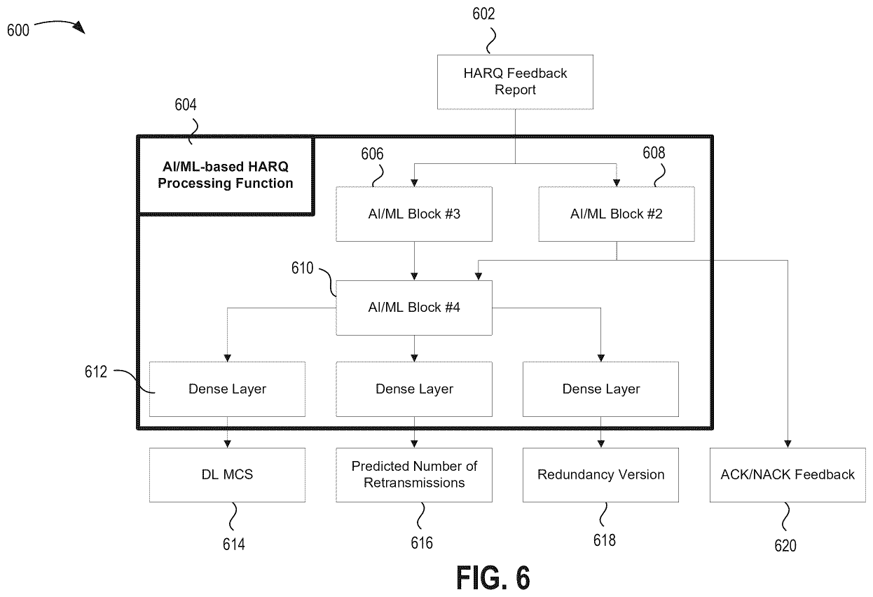

Referring now to FIG. 6, an example method 600 including an AI/ML-based HARQ processing function 604 for processing a HARQ feedback report 602 is illustratively depicted. The HARQ feedback report 602 received from the WTRU may be input into AI/ML block #2 608 and AI/ML block #3 606 concurrently. Each of the AI/ML block #2 608 and AI/ML block #3 606 may include one or multiple hidden layers (e.g., dense layers, convolutional layers, and/or other types of neural layers). An ACK/NACK feedback 620 may be generated as an output of the AI/ML block #2 608. The output of the AI/ML block #3 606 and the ACK/NACK feedback 620 may then be input into an AI/ML block #4 610. The AI/ML block #4 610 may include one or multiple hidden layers (e.g., an addition layer, a concatenation layer, dense layers, convolutional layers, and/or other neural network layers). From the output of the AI/ML block #4 610, three different outputs may be concurrently generated. Each of the three outputs may be passed through a corresponding dense layer 612 to generate one of the components of a transmission/retransmission (Tx/ReTx) recommendation. The Tx/ReTx recommendation may comprise a downlink modulation and coding scheme (DL MCS) 614, a predicted number of retransmissions 616 for the generated DL MCS 614, and a redundancy version 618.

Output data may include the ACK/NACK feedback 620 associated with the DL transmitted transport blocks (TBs) and/or code block groups (CBGs) (e.g., when data transmission is based on CBGs), and/or the Tx/ReTx recommendation. The Tx/ReTx recommendation may include the DL MCS 614, the predicted number of retransmissions 616 for the generated DL MCS 614, and/or the redundancy version 618.

Based on the above, the AI/ML-based HARQ feedback may be a multi-task AI/ML-based function that may comprise two tasks. The first task (or a group of tasks) may be ACK/NACK feedback reconstruction, and the second task (or a group of tasks) may be Tx/ReTx recommendation. Training may be performed using curriculum learning to train the first and second tasks.

For the first task, i.e., the ACK/NACK feedback reconstruction, training may be performed online, for example jointly at the WTRU and the network. During training, the WTRU may transmit ground-truth ACK/NACK feedback to the network. The network may compute a loss function to be minimized. The loss function may be a measured distance (e.g., mean absolute error (MAE), binary cross entropy (BCE), and/or other distance functions) between the reconstructed ACK/NACK feedback generated by the AI/ML-based HARQ processing function 604 and the ground-truth ACK/NACK feedback received from the WTRU. The network may compute derivatives of the loss function with respect to the received HARQ feedback report 602 from the WTRU in order to update the AI/ML model of the AI/ML-based HARQ processing function 604. The network may then transmit the computed derivatives to the WTRU. The WTRU may compute derivatives of the loss function with respect to the input data of the AI/ML-based HARQ feedback generation function and may update parameters of its AI/ML model accordingly. The network may continue to monitor training of the AI/ML-based HARQ feedback generation function and the AI/ML-based HARQ processing function 604 by evaluating the behavior of the loss function. If a value of the loss function falls below a certain threshold, the network may stop training and may notify the WTRU to stop the training.

After completing training of the first task, the WTRU may train the second task. For the second task, online end-to-end training may be performed, for example jointly at the WTRU and the network. During training, the WTRU may receive DL training data based on a Tx/ReTx recommendation designed by the network. The WTRU may compute a loss function to be minimized. The loss function to be minimized may be a measured distance, such as binary cross entropy (BCE), approximate bit error rate (BER), and/or approximate block error rate (BLER). The WTRU may compute derivatives of the loss function and may transmit the derivatives to the network. The network may then compute derivatives of the loss function with respect to the HARQ feedback report 602 received from the WTRU to update the AI/ML model of the AI/ML-based HARQ processing function 604. The network may transmit the computed derivatives to the WTRU. The WTRU may compute derivatives of the loss function with respect to input data of the AI/ML-based HARQ feedback generation function and may update parameters of its AI/ML model accordingly. The WTRU and the network may continue to monitor training of the AI/ML-based HARQ feedback generation function and the AI/ML-based HARQ processing function 604 by evaluating behavior of the loss function. If a value of the loss function is below a certain threshold, the WTRU and the network may stop training.

1. A wireless transmit/receive unit (WTRU) comprising:
a processor configured to:
determine to train an artificial intelligence or machine learning (AI/ML)-based function;
determine that the AI/ML-based function to be trained is a multi-task AI/ML-based function;
determine to perform curriculum learning for the multi-task AI/ML-based function to be trained, wherein the determination to perform curriculum learning is based on one or more of a command or message received from a network or a performance measurement;
receive, from a network, a configuration message associated with curriculum learning of a multi-task AI/ML-based function, wherein the multi-task AI/ML-based function is associated with a plurality of tasks;
train at least a subset of the plurality of tasks based on the configuration message; and
send a report to the network, wherein the report indicates a status of the training of the plurality of tasks associated with the multi-task AI/ML-based function.

2. The WTRU of claim 1, wherein each task of the plurality of tasks defines a different learning objective of the multi-task AI/ML-based function;
wherein each task of the plurality of tasks defines a different problem that is solved by the multi-task AI/ML-based function;
wherein each task of the plurality of tasks is defined by a different dataset or target label;
wherein each task of the plurality of tasks is defined by a different loss function; and/or
wherein each task of the plurality of tasks is associated with a different skill or ability of the multi-task AI/ML-based function.

3. The WTRU of claim 1, wherein the processor is configured to determine to transition from training a current task to a next task of the plurality of tasks associated with the multi-task AI/ML-based function based on one or more of an indication received from the network or a comparison of a performance metric associated with the current task to a configured threshold; and
wherein the processor is configured to determine an order of the subset of the plurality of tasks to be trained based on one or more of task complexity, training difficulty, dependency relationships among the tasks, performance measurements associated with the tasks, or recommendations received from the network.

4. The WTRU of claim 1, wherein the configuration message comprises one or more of an indication of training data used to train the plurality of tasks associated with the multi-task AI/ML-based function, a list of tasks associated with the multi-task AI/ML-based function, a training approach to be used for training the plurality of tasks associated with the multi-task AI/ML-based function, or a training data used to train the plurality of tasks associated with the multi-task AI/ML-based function;
wherein the processor is configured to determine the plurality of tasks to be trained based on one or more of a command triggering curriculum learning, the configuration message, or AI/ML-based function AI/ML model performance;
wherein the subset of the plurality of tasks is based on received command/message triggering curriculum learning, received command/message triggering a start of training a set of tasks, curriculum learning configuration message, or AI/ML-based function AI/ML model performance.

5. The WTRU of claim 1, wherein the configuration message comprises an indication of one or more of a training approach for the plurality of tasks, an allocation of training data, a mechanism to generate or reconstruct training data, or a mechanism to transfer training data to or from the WTRU and the network, wherein the training approach comprises one or more of parallel training, serial training, or cyclic training.

6. The WTRU of claim 1, wherein the processor is configured to:
receive one or more AI/ML models for the AI/ML-based function, wherein the one or more AI/ML models comprise one or more of a single AI/ML model for the entire multi-task AI/ML-based function or a set of AI/ML models that are associated with the multi-task AI/ML-based function, where each AI/ML model of the set of AI/ML models corresponding to a specific task of the plurality of tasks.

7. The WTRU of claim 1, wherein the report comprises:
training feedback associated with one or more of the plurality of tasks, wherein the training feedback comprises one or more of a gradient, a loss value, a derivative of a loss value, a reward signal, or state information.

8. The WTRU of claim 1, wherein the processor is configured to receive an indication to stop training from the network.

9. The WTRU of claim 1, wherein the processor is configured to determine to perform curriculum learning of the multi-task AI/ML-based function based on one or more of a command received from the network, detection of model drift of the multi-task AI/ML-based function, or based on a measurement associated with the multi-task AI/ML-based function falling below a threshold.

10. The WTRU of claim 1, wherein the processor is configured to determine to transition from training a current task to a next task of the plurality of tasks based on a performance measurement threshold associated with the current task.

11. A method implemented by a wireless transmit/receive unit (WTRU), the method comprising:
determining to train an artificial intelligence or machine learning (AI/ML)-based function;
determining that the AI/ML-based function to be trained is a multi-task AI/ML-based function;
determining to perform curriculum learning for the multi-task AI/ML-based function to be trained, wherein the determining to perform curriculum learning is based on one or more of a command or message received from a network or a performance measurement;
receiving, from the network, a configuration message associated with curriculum learning of a multi-task AI/ML-based function, wherein the multi-task AI/ML-based function is associated with a plurality of tasks;
training at least a subset of the plurality of tasks based on the configuration message; and
sending a report to the network, wherein the report indicates a status of the training of the plurality of tasks associated with the multi-task AI/ML-based function.

12. The method of claim 11, wherein each task of the plurality of tasks defines a different learning objective of the multi-task AI/ML-based function;
wherein each task of the plurality of tasks defines a different problem that is solved by the multi-task AI/ML-based function;
wherein each task of the plurality of tasks is defined by a different dataset or target label;
wherein each task of the plurality of tasks is defined by a different loss function; and/or
wherein each task of the plurality of tasks is associated with a different skill or ability of the multi-task AI/ML-based function.

13. The method of claim 11, further comprising:
determining to transition from training a current task to a next task of the plurality of tasks associated with the multi-task AI/ML-based function based on one or more of an indication received from the network or a comparison of a performance metric associated with the current task to a configured threshold; and
determining an order of the subset of the plurality of tasks to be trained based on one or more of task complexity, training difficulty, dependency relationships among the tasks, performance measurements associated with the tasks, or recommendations received from the network.

14. The method of claim 11, wherein the configuration message comprises one or more of an indication of training data used to train the plurality of tasks associated with the multi-task AI/ML-based function, a list of tasks associated with the multi-task AI/ML-based function, a training approach to be used for training the plurality of tasks associated with the multi-task AI/ML-based function, or a training data used to train the plurality of tasks associated with the multi-task AI/ML-based function;
wherein the method further comprises determining the plurality of tasks to be trained based on one or more of a command triggering curriculum learning, the configuration message, or AI/ML-based function AI/ML model performance; and
wherein the subset of the plurality of tasks is based on one or more of a received command or message triggering curriculum learning, a received command or message triggering a start of training a set of tasks, a curriculum learning configuration message, or AI/ML-based function AI/ML model performance.

15. The method of claim 11, wherein the configuration message comprises an indication of one or more of a training approach for the plurality of tasks, an allocation of training data, a mechanism to generate or reconstruct training data, or a mechanism to transfer training data to or from the WTRU and the network, wherein the training approach comprises one or more of parallel training, serial training, or cyclic training.

16. The method of claim 11, further comprising:
receiving one or more AI/ML models for the AI/ML-based function, wherein the one or more AI/ML models comprise one or more of a single AI/ML model for the entire multi-task AI/ML-based function or a set of AI/ML models that are associated with the multi-task AI/ML-based function, where each AI/ML model of the set of AI/ML models corresponds to a specific task of the plurality of tasks.

17. The method of claim 11, wherein the report comprises:
training feedback associated with one or more of the plurality of tasks, wherein the training feedback comprises one or more of a gradient, a loss value, a derivative of a loss value, a reward signal, or state information.

18. The method of claim 11, further comprising receiving an indication to stop training from the network.

19. The method of claim 11, further comprising:
determining to perform curriculum learning of the multi-task AI/ML-based function based on one or more of a command received from the network, detection of model drift of the multi-task AI/ML-based function, or a measurement associated with the multi-task AI/ML-based function falling below a threshold.

20. The method of claim 11, further comprising:
determining to transition from training a current task to a next task of the plurality of tasks based on a performance measurement threshold associated with the current task.
